(19) United States
(12) Patent Application Publication
(10) Pub. No.: US 2003/0029622 A1
(43) Pub. Date: Feb. 13, 2003

(54) Method and device for distributing liquid media

(76) Inventors: Torsten Clauss, Berlin (DE); Andreas Schmidt, Besterusen (DE); Wassili Jansen, Berlin (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/204,964

(22) PCT Filed: Feb. 27, 2001
(86) PCT No.: PCT/DE01/00811

(30) Foreign Application Priority Data
Feb. 29, 2000 (DE) 100 10 881.4

(51) Int. Cl. A62C 2/00

(52) U.S. Cl. 169/47; 169/46; 169/37

(57) ABSTRACT

The invention relates to a method and a device for distributing liquid media, in particular extinguishing fluids for fighting fires, in the form of a mist or a stream of large droplets from a supply line which is maintained at a constant low-pressure, in rooms, for example in living spaces and recreation rooms, or similar. The aim of the invention is to provide a method and a device of the aforementioned type which can be used to produce a fine mist of small droplets and a jet spray of large droplets at separate moments, at approximately the same operating pressure of the extinguishing fluid, depending on the outbreak and the development of the fire, whilst at the same time minimising water consumption, reducing water damage caused during a fire and increasing cost-effectiveness, by creating a modular system which can be universally installed. To achieve this, the intensity of the vortex and the proportion of fine or large droplets in the spray cone is adjusted by regulating the quantity and speed of the flow of the sub-streams of extinguishing fluid, either separately or synchronously between a zero value and a maximum throughput value. In addition, the adjusting process is controlled by a signal generator which responds to the outbreak and dynamic development of the fire.

The invention relates to a method of distributing liquid media, in particular extinguishing liquids like water or the like in the form of a mist or a large-droplet stream from a low-pressure supply line into spaces, in particular living or household rooms or the like to fight fire where the pressurized extinguishing liquid is made into individual streams and these streams are separately set in rotation and as a result the streams are combined to form a spray cone.

The invention further relates to an apparatus for carrying out the above-described method with a support on which is provided a fitting for connection to a low-pressure supply line, a connection body, and a turbulence chamber surrounding the connection body, the turbulence chamber being traversed by separate streams of the extinguishing liquid.

Sprinkler for applying extinguishing liquids in stationary fire-extinguishing systems have been known for long.

German 2,703,459 describes a sprinkler nozzle for upright, horizontal, and pendant mounting with a nozzle body and an impingement plate that is connected with the nozzle body with at least two support elements fixed to an edge of the impingement plate as well as an arrangement which blocks the nozzle opening of the sprinkler nozzle on manufacture and which is formed of a closure element sealing the nozzle opening and a release element pressing against the later but which can release its force on the closure element and allow the extinguishing-water stream to exit. The closure element is provided with an ejector which, when the retaining force is released, works with the force of the extinguishing water, the ejector being fixed to the joined parts of the sprinkler head when same is in standby condition.

German 2,924,654 describes a sprinkler for automatic fire-extinguishing systems, which is comprised of a housing defining a flow passage for the extinguishing liquid, a two-arm frame on the housing carrying a distributor cap, a cover cap closing the flow passage, and an assembly between the two caps which has a lever, a support strut with two laterally perforated tabs, and a temperature monitor set between the tabs. The support strut has a projecting antijam arm whose longitudinally bent main portion extends generally parallel to the struts and which on sprinkler activation engages against the frame and distributor cap.

Other solutions (EP 0,505,762, U.S. Pat. No. 3,834,463, or U.S. Pat. No. 5,505,383) serve mainly for applying a large-droplet spray of the extinguishing agent in nearly constant amounts over time, because on one hand the diameters of the outlet openings of the sprinklers is fixed and on the other hand the extinguishing-media pressure in the supply line is constant. This leads in a fair mainly to usage of a great deal of water by the stationary extinguishing system with all the inherent disadvantages of overdimensioning the pumps, pipes, and storage containers for extinguishing media in the system.

The sprinkler nozzle described in German 3,624,939 produces a spray stream that has small and large droplets, more particularly small drops in a relatively small edge area and large drops in a central area. This is done in that the outlet opening or the outlet openings are downstream of inlet openings whose flow cross section is somewhat smaller than the flow cross section of the outlet opening or openings.

A spray nozzle for producing a mist with low pressure, in particular to fight fire in stationary water-mist fire-extinguishing systems is known from EP 0,671,216. This known nozzle is built radially into a pipe of a fire-extinguishing system and is comprises of a housing holding a flow body that traversed by a conically tapering turbulence/mixing chamber. The surface oft his turbulence/mixing chamber is formed with spiral grooves with axial inlets that communicate with inlet openings for the water. An annular space permits a further stream of water into the inner turbulence/mixing chamber. There is thus stream separation. The one path leads via the inlet openings and the twist passages to cylindrical nozzle openings and there produces and inner spray cone. The second path extends via the annular chamber and tangential bores to an annular gap from which the water exits as an outer spray cone.

The known solution serves mainly for applying a large-droplet inner spray stream and a fine-droplet outer spray stream. It is not possible to obtain an initial fine-drop spray mist when the fire starts and a large-droplet spray mist when the fire is under way to apply the extinguishing media. All of the above-cited disadvantages of the state of the art have nothing to do with this known solution.

Starting from this state of the art it is an object of the invention to provide a method and apparatus of the above-described type by means of which it is possible with nearly constant supply pressure of the extinguishing means to, with time, in accordance with the whether the fire has just started or s under way to apply a fine-droplet spray mist and a large-droplet spray mist so as to minimize water use, reduce water damages in fire, and to increase the efficiency of the fire-extinguishing system in any installation.

This object is attained by a method and an apparatus of the above-described type with the characterizing features of claims 1 and 4. Preferred embodiments of the method and of the apparatus are seen in the dependent claims.

The invention is characterized above all by its simplicity and is particularly applicable to wet systems. In contrast to the known state of the art a simple flow regulation in the separated and rejoined streams of the extinguishing fluid produces an excellent influencing of the turbulence intensity in dependency of whether the fire has just started or is underway. When the streams are produces it is further possible to impinge small and large surfaces of an object to be protected with spray cones and spray streams of different shape and composition. According to the above-given requirements as a fire starts up the apparatus according to the invention produces at first a mist like droplet stream. The signal generator can in this case be a smoke detector. As the fire develops a large-droplet spray stream is needed so a further detector, for instance a heat detector, produces a signal which acts on the adjuster of the apparatus in that the flow cross section of the opening of the slot is enlarged.

The solution according to the invention reduces water use to fight a fire substantially and simultaneously reduces water damage caused by the unregulated outflowing of the extinguishing medium. The fire-extinguishing systems can be better tailored to the dynamics of the fire as it starts and develops.

Further advantages and details can be seen in the following description with reference to the attached drawings.

The invention is more closely described below with reference to a specific embodiment.

Therein:

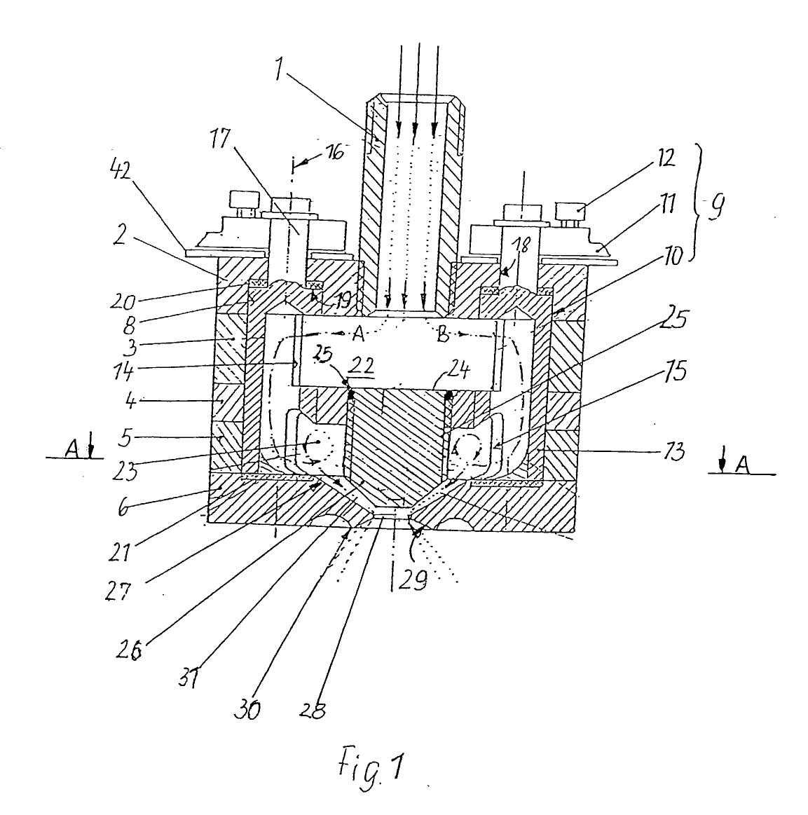

FIG. 1 is a side sectional view of the apparatus according to the invention, the stream flow being shown

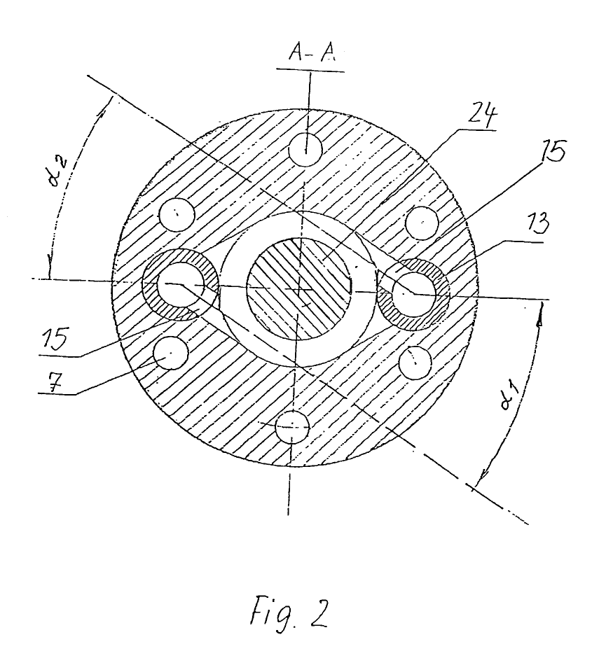

FIG. 2 is a section taken along line A-A of FIG. 1;

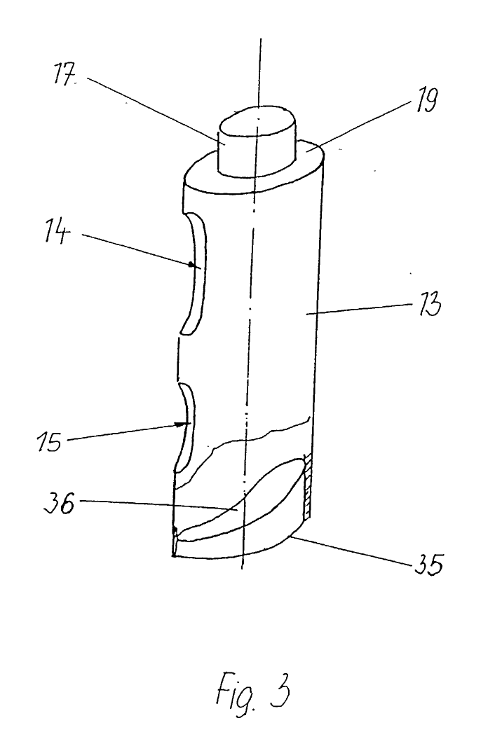

FIG. 3 is a perspective view of the housing; and

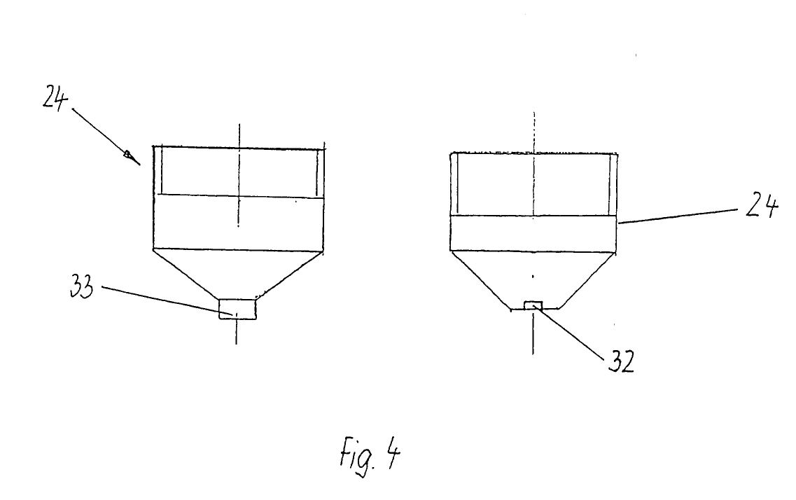

FIG. 4 is a view of the nozzle.

The apparatus according to the invention is comprised as shown in FIG. 1 of a support body provided with an inlet fitting 1 and itself formed of a top plate 2, a distributing-chamber ring 3, a spacer plate 4, a turbulence-chamber ring 5, and an outlet plate 6, all secured by unillustrated screws in bolt holes 7 extending through all the plates and rings. The inlet 1 is screwed centrally into the top plate 2. The top plate 2 and the spacer plate 4 contain structure forming passages 8 adjustable by respective adjusters 9. The adjusters 9 are each comprised of a hollow sleeve-like body 10 closed at both ends, an adjustment arm 11 coupled with the hollow body 10 and a brake mechanism 12 or setting mechanism 34. A wall 13 of each hollow body 10 is formed with two axially aligned slot openings 14 and 15 (see FIGS. 2 and 3). The hollow body 10 has on its upstream end near the inlet 11 a pin 17 defining an axis 16 and extending out through a hole 18 in the top plate 2. The pin 17 carries the adjustment arm 11 which can be fixed angularly by the brake mechanism 12.

The distributing-chamber ring 3 and the turbulence-chamber ring 5 are of the same axial heights as the respective slots 14 and 15. FIG. 3 shows the position of the slots 14 and 15 of the hollow body 10 in perspective. In this embodiment the hollow body 10 is fitted with a plug-like insert 35 which is internally formed as a flow deflector with an angled upper surface 36.

The pin 17 is in this embodiment of somewhat smaller diameter than the hollow body 10 so that the hollow body 10 has a shoulder 19 on which sits a seal ring 20 that supports and seals the hollow body 10 with respect to the top plate 2. The hollow body 10 thus passes through the distributing-chamber ring 3, the spacer plate 4, and the turbulence-chamber ring 5 and sits on a seal/bearing disk 21 seated in the outlet plate 6. On rotation of the pins 17 about the hollow-body axes the angular positions of the slots 14 changes relative to a distributing chamber 22 formed by the distributing-chamber ring 3 as does the flow cross section of the slot 14. The flow cross section of the slot openings 15 into a turbulence chamber 23 are similarly changed.

Axially centered on the inlet in the spacer plate 4 is a cylindrical closure body 24, screw-mounted so as to be vertically axially adjustable. This is done by simply providing a snap ring 25. The closure body 24 has a frustoconical head 26. The head 26 of the closure body 24 extends into a funnel-shaped opening 27 of the output plate 6 that is flared into the turbulence chamber 23 and ends in an outlet opening 28 formed with an outlet flare 29 ending at a separation edge 30. The outlet flare 29 can be of frustoconical or other shape. The head 26 and opening 27 form a funnel-shaped passage 31 whose flow cross section can be changed by adjusting the height of the closure body 24.

The water admitted by the inlet 1 is distributed as shown in FIG. 1 in the distributing chamber 22 into two streams A and B. The two streams A and B pass through the slots 14 of both adjusters 9 and are deflected down through the hollow bodies 10 to exit therefrom through the slots 15 tangentially into the turbulence chamber 23 where they mix turbulently together and are then fed to the funnel-shaped outlet passage 31. The two combined streams exit through the outlet opening 28 of the outlet plate 6.

According to how the adjusters 9 are set, the sizes of the flow cross sections of the slots 14 and 15 vary, as does the amount of turbulence in the joined streams A and B between minimal and maximal values. On changing the adjustment angle α1 and/or α2 by means of the adjusters 9 the water-flow speed changes in the slots 15 presuming constant water pressure (see Fig .2). An increase of the angles α1 or α2 or of both simultaneously decreases the effective size of the slot 15 and correspondingly increases the flow speed and thus the misting ability of the water. In this case there is a spray with mainly fine droplets that is in particular useful at the start of a fire. A decrease of the angle α1 or α2 or of both simultaneously decreases the water rotation and the flows work against each other. In this case there is a spray that is mainly large droplets.

If the adjuster 9 is turned so far that the slits 15 are closed relative to the turbulence chamber 23, no more flow is possible. The invention is therefore in standby condition.

FIG. 4 shows the closure body 24, which has slit-shaped cutouts 32 in its frustoconical head 26 or has a head 27 with a profiling 33 that is turned toward the flow passage 31 or which extends thereinto. The cutout 32 or the profiling 33 increases the turbulence of the moving water.

As a result of the adjustability of the free flow cross sections of the slots from outside it is possible to control or adjust in accordance with the dynamics of a fire. Signals obtained from an unillustrated signal generator indicating a fire that is just starting or in progress are translated into adjustment signals for the adjusters 9 and the nozzle according to the invention can react dynamically as the fire develops by operating the adjustment mechanism 34.

List of the used reference numerals

Inlet 1

Top plate 2

Distributing-chamber ring 3

Spacer plate 4

Turbulence-chamber ring 5

Outlet plate 6

Bolts 7

Bores 8

Adjuster 9

Hollow body of 9 10

Adjustment arm of 9 11

Brake mechanism 12

Wall of 10 13

Inlet slot opening 14

Outlet slot opening 15

Axis 16

Pin 17

Bore 18

Shoulder of 10 19

Seal and bearing washer 20

Seal and bearing disk 21

Distributing chamber 22

Turbulence chamber 23

Closure body 24

Snap ring 25

Closure-body head 26

Funnel-shaped opening 27

Outlet opening 28

Flare into 6 29

Separation edge 30

Funnel-shaped passage 31

Slit-shaped cutout 32

Profiling 33

Adjustment mechanism 34

Insert 35

Flow deflector 36

Adjustment angle α1

Adjustment angle α2

1. A method of applying liquid media, in particular extinguishing liquids like water or the like in the form of a mist or a large-droplet stream from a low-pressure supply line into spaces, in particular living or household rooms or the like to fight fire where the pressurized extinguishing liquid is made into individual streams and these streams are separately set in rotation and as a result the streams are combined to form a spray cone, characterized in that the turbulence intensity and the ratio of small and large droplets in the spray are adjusted between zero and a maximal value by adjustment the flow volume and the flow speed of streams (A and B) of the extinguishing liquid either separately or synchronously and that the adjustment is controlled by a signal generator after a fire starts dynamically in accordance with development of the fire.

2. The method according to claim 1, characterized in that the signal generator can be an ionization smoke-detector, an optical smoke detector, a maximum-temperature detector, a temperature-differential detector, or a flame detector.

3. The method according to claim 1, characterized in that the volume of flow and the speed of flow of the individual streams is first set at a turbulence density that produces a mist.

4. An apparatus for carrying out the method according to claim 1 having a support with an inlet for connection to a supply line maintained under a continuous low pressure, a closure body, and a turbulence chamber surrounding the closure body, separate streams of the extinguishing liquid passing through the turbulence chamber, characterized in that the closure body (24) and the turbulence chamber (23) are downstream of a common distributing chamber (22) and that the distributing chamber (22) and the turbulence chamber (23) are connected by an adjuster (9) which controls the flow cross section of an upstream opening (14) into the distributing chamber (22) and of a downstream opening (14) into the turbulence chamber and which is connected to its own or a common signal generator.

5. The apparatus according to claim 4, characterized in that the adjuster is formed of a closed-end cylindrical hollow body (10) with axially extending slot openings (14 and 15) into the distributing chamber (22) and into the turbulence chamber (23), an axially extending pivot shaft (16) for pivoting the hollow body (10), an adjustment mechanism (34) for synchronously adjusting the hollow cylinders with their slots (14 and 15) in the chambers (22 and 23).

6. The apparatus according to claim 4, characterized in that the adjuster (9) is formed of at least two end-closed cylindrical hollow cylinders with axially extending slot openings (14 and 15) into the distributing chamber (22) and into the turbulence chamber (23), respective axially extending pivot shafts (16) for rotating the hollow bodies, respective adjustment arms (11) fixed on the pivot shafts for separately adjusting the flow cross section of the slots (14 and 145), and an arresting mechanism (12) for fixing the adjusted position of the adjustment arm.

7. The apparatus according to claim 5 or 6, characterized in that the slits (14 and 15) are separate or formed as a common throughgoing opening, the flow cross section for the extinguishing medium being determined by the individual openings through the spacer plate (4).

8. The apparatus according to claims 4 to 7, characterized in that the support body is comprised of an outlet plate (6) with a central outlet opening (28,), a turbulence-chamber ring (5), a spacer plate (4), a distributing-chamber ring (3), and a top plate (2)_that are held together on the top plate (2) by peripherally distributed bolts (8).

9. The apparatus according to claims 6 to 8, characterized in that the hollow body (10) has a floor formed as an insert (35) that is provided internally with a flow deflector (36).

10. The apparatus according to one or more of preceding claims 4 to 9, characterized in that the top plate (2) is provided near its outer periphery with diametrally opposite bores (8) which extend through the distributing-chamber ring (3), the spacer plate (4), and the turbulence-chamber ring (5) and which receive the hollow bodies (10) of the adjustment device.

11. The apparatus according to one or more of the preceding claims 4 to 10, characterized in that the rotary shaft (16) on the hollow body (10) has a smaller diameter than the hollow body (10) than that of the pin (17) and the hollow body (10) is sealed in the bore (8) at both ends with sealing and bearing disks (20 and 21).

12. The apparatus according to one or more of preceding claims 4 to 11, characterized in that between the rotary shaft (16) and the hollow body (10) there is a shoulder (19) against which the seal and bearing washer (20) bears and that engages the top plate (2).

13. The apparatus according to one or more of preceding claims 4 to 12, characterized in that the sealing and bearing disk (21) is provided between the outlet plate (6) and the hollow body (10).

14. The apparatus according to one or more of preceding claims 4 to 13, characterized in that a funnel-shaped opening (27) flaring toward the closure body (24) is provided in the outlet plate (6) and opens into the outlet opening (28) which merges into an outlet flare (29) with a separation edge (30).

15. The apparatus according to claim 14, characterized in that the outlet flare (30) has a frustoconical or other shape.

16. The apparatus according to one or more of preceding claims 4 to 15, characterized in that the closure body (24) has a downstream frustoconically tapered closure-body head (26) that projects far enough into the funnel-shaped opening (27) that between the closure-body head (26) and the funnel-shaped opening (27) there is a funnel-shaped passage (31) , the outlet opening (28) of the outlet plate (6) being axially aligned with the inlet (1).

17. The apparatus according to one or more of preceding claims 4 to 16, characterized in that the closure body (24) is mounted in axial alignment with the inlet (1) in the spacer plate (4) to adjust the flow cross section of the funnel-shaped opening (31).

18. The apparatus according to one or more of preceding claims 4 to 17, characterized in that the closure body (24) has cutouts (32) or a profiling (33) on its closure-body head (26) extending into the funnel-shaped passage (31).

19. The apparatus according to claim 4, characterized in that the signal generator is an ionization smoke-detector, an optical smoke detector, a maximum-temperature detector, a temperature-differential detector, or a flame detector.
